(19) United States
(12) Patent Application Publication
(10) Pub. No.: US 2019/0195083 A1
(43) Pub. Date: Jun. 27, 2019

(54) BACKUP DEVICE FOR LINK MECHANISM OF STEAM TURBINE, STEAM TURBINE, AND METHOD FOR MODIFYING STEAM TURBINE

(71) Applicant: MITSUBISHI HEAVY INDUSTRIES COMPRESSOR CORPORATION, Tokyo (JP)

(72) Inventor: Kenichi Nishiyama, Hiroshima (JP)

(73) Assignee: MITSUBISHI HEAVY INDUSTRIES COMPRESSOR CORPORATION, Tokyo (JP)

(21) Appl. No.: 16/157,284

(22) Filed: Oct. 11, 2018

(30) Foreign Application Priority Data
Dec. 21, 2017 (JP) 2017-245490

(51) Int. Cl. F01D 17/14; F16K 31/04

(52) U.S. Cl. CPC F01D 17/145; F16K 31/047

(57) ABSTRACT

To provide redundancy to a link mechanism provided in a steam turbine. A backup device for a link mechanism includes a stand-by plate suspended from a regulating valve lever as a first link and located immediately below a contact stopper provided on a main rod as a second link. The backup device preferably further includes a clamp that is provided on the regulating valve lever and suspends the stand-by plate. If the links are disjoined due to damage to a joint that joins the links of the link mechanism and thus the main rod is disengaged from the regulating valve lever by its own weight, the contact stopper provided on the main rod is locked by the stand-by plate located immediately below the contact stopper.

### BACKGROUND

### Field

The present disclosure relates to a backup device for a link mechanism for a regulating valve or the like of a steam turbine, a steam turbine, and a method for modifying a steam turbine.

### Description of the Related Art

An operation system of a regulating valve that regulates a flow rate of steam to be supplied to a steam turbine typically includes a link mechanism (for example, JP2013-72349A (FIG. 11 and FIG. 12) and JP8-200009A (FIG. 2)).

The operation system of the regulating valve used for drive control of the steam turbine includes an actuator with a motor, a pilot valve and a servomotor for obtaining oil pressure for driving the regulating valve, a regulating valve lever connected to a piston provided in the servomotor, and a feedback lever that coordinates with the regulating valve lever, and these components are coupled by links. The regulating valve lever and the feedback lever are coupled by a rod.

To ensure reliability of an operation of the steam turbine, it is important to prepare for damage due to vibration or aged deterioration of the link mechanism involved in an operation of the regulating valve or the like.

Then, the present disclosure has an object to provide redundancy to a link mechanism provided in a steam turbine.

### SUMMARY

The present disclosure provides a backup device for a link mechanism, the link mechanism being configured to be involved in an operation of a valve provided in a steam turbine, and provided between the valve driven by oil pressure and an actuator to which an electric signal is supplied, wherein the backup device includes a locking portion configured to lock a contact portion of one of a first link and a second link included in the link mechanism by relative displacement of the first link and the second link caused by disjoining of the first link and the second link, on the other of the first link and the second link.

The backup device of the present disclosure preferably includes a stand-by member as the locking portion suspended from the first link and located immediately below at least a part of the second link.

“Located immediately below” herein refers to being placed below at least a part of the second link with a gap from at least the part. The stand-by member is located away from the second link in normal time when joining of the links is safe, but stands by near at least the part of the second link in preparation for damage to a joint or the like.

The backup device of the present disclosure further includes a support portion that is provided on the first link and suspends the stand-by member.

It is preferable that the backup device of the present disclosure includes a rod that suspends the stand-by member from the support portion, one end side of the rod is joined to the support portion by a pin, and the other end side of the rod is joined to the stand-by member by a pin.

In the backup device of the present disclosure, it is preferable that one end and the other end of the rod each have a rod end bearing into which the pin is inserted.

In the backup device of the present disclosure, it is preferable that a pin that joins the first link and the second link is used as the support portion, and the stand-by member is suspended from the pin.

In the backup device of the present disclosure, it is preferable that the stand-by member is located immediately below a contact stopper provided on an outer peripheral portion of the second link.

In the backup device of the present disclosure, it is preferable that at least one of the contact stopper and the stand-by member is formed into a spherical shape protruding toward the other.

In the backup device of the present disclosure, it is preferable that the stand-by member is located immediately below at least an end of the second link.

In the backup device of the present disclosure, it is preferable that the stand-by member is suspended from the support portion provided on an outer peripheral portion of the first link.

In the backup device of the present disclosure, it is preferable that the link mechanism includes a third link connected to the second link, and the backup device includes a first stand-by member as the stand-by member located immediately below the contact stopper provided on the outer peripheral portion of the second link, and a second stand-by member suspended from the support portion provided on the outer peripheral portion of the second link and located immediately below at least an end of the third link.

In the backup device of the present disclosure, it is preferable that an intermediate link included in the link mechanism couples the first link and the second link, and the stand-by member is suspended from the first link and located immediately below at least the end of the second link.

In the backup device of the present disclosure, it is preferable that the valve is a regulating valve configured to regulate a flow rate of steam to be supplied to the steam turbine, and the link mechanism includes a regulating valve lever rockable according to an opening of the regulating valve, and a feedback lever configured to coordinate with the regulating valve lever.

A steam turbine of the present disclosure includes the backup device described above.

The present disclosure also provides a method for adding a backup device including a stand-by member to a link mechanism. The link mechanism is configured to be involved in an operation of a valve provided in a steam turbine, and provided between the valve driven by oil pressure and an actuator to which an electric signal is supplied, wherein the method includes a locking structure adding step of adding a locking structure to a first link and a second link included in the link mechanism, the locking structure being configured such that a locking portion configured to lock a contact portion of one of the first link and the second link by relative displacement of the first link and the second link caused by disjoining of the first link and the second link is provided on the other of the first link and the second link.

In the modifying method of the present disclosure, the locking structure adding step includes an immediately-below placing step of suspending the stand-by member from the first link to place the stand-by member immediately below at least a part of the second link.

In the modifying method of the present disclosure, it is preferable that the locking structure adding step includes a step of providing a clamp on the first link, a step of providing a contact stopper on an outer peripheral portion of the second link, and a step of mounting one end side of a rod to the clamp, and in the immediately-below placing step, the stand-by member is mounted to the other end side of the rod, and the stand-by member is placed around the outer peripheral portion of the second link immediately below the contact stopper.

In the modifying method of the present disclosure, it is preferable that the locking structure adding step includes a step of providing a support portion on an outer peripheral portion of the first link, and a step of mounting one end side of a rod to the support portion, and in the immediately-below placing step, the stand-by member is mounted to the other end side of the rod below at least a part of the second link to be placed immediately below at least the part of the second link.

If a joint or the like that joins the links of the link mechanism is damaged to disjoin the links and thus disjoin the first link and the second link, the contact portion of one link is locked by the locking portion of the other link.

Then, the first link and the second link are joined based on engagement between the contact portion and the locking portion. As such, the backup device replaces the joining of the first link and the second link, thereby providing redundancy to the link mechanism provided in the steam turbine.

### BRIEF DESCRIPTION OF THE DRAWINGS

FIG. 1 is a schematic diagram of a steam turbine and a link mechanism involved in an operation of a regulating valve of the steam turbine according to an embodiment of the present disclosure;

FIG. 2 is a perspective view of a regulating valve driving device including the link mechanism in FIG. 1;

FIG. 3 is a perspective view of an upper backup device corresponding to a section III in FIG. 1 and FIG. 2;

FIG. 4 is an exploded perspective view of a backup rod suspended from a clamp member provided on a regulating valve lever;

FIG. 5A is a side view of a state of the regulating valve lever and the upper backup device corresponding to a maximum opening of the regulating valve, and FIG. 5B is a side view of a state of the regulating valve lever and the upper backup device corresponding to a minimum opening (closed);

FIG. 6 is a perspective view of a lower backup device corresponding to a section VI in FIG. 1 and FIG. 2;

FIG. 7 is a side view of the lower backup device viewed in the direction of arrow VII in FIG. 6;

FIG. 8 is a schematic view mainly of a state of the upper backup device when a main rod is disengaged from the regulating valve lever;

FIG. 9 is a schematic view mainly of a state of the lower backup device when a feedback lever is disengaged from the main rod;

FIG. 10 is a schematic view of a backup device according to a first variant of the present disclosure;

FIG. 11 is a schematic view of a backup device according to a second variant of the present disclosure;

FIG. 12 is a perspective view of a backup device according to a third variant of the present disclosure; and

FIG. 13A and FIG. 13B each show a backup device according to a fourth variant of the present disclosure, FIG. 13B being a perspective view of a section XIIIb of FIG. 13A.

### DETAILED DESCRIPTION OF THE PREFERRED EMBODIMENT

Now, with reference to the accompanying drawings, an embodiment of the present disclosure will be described.

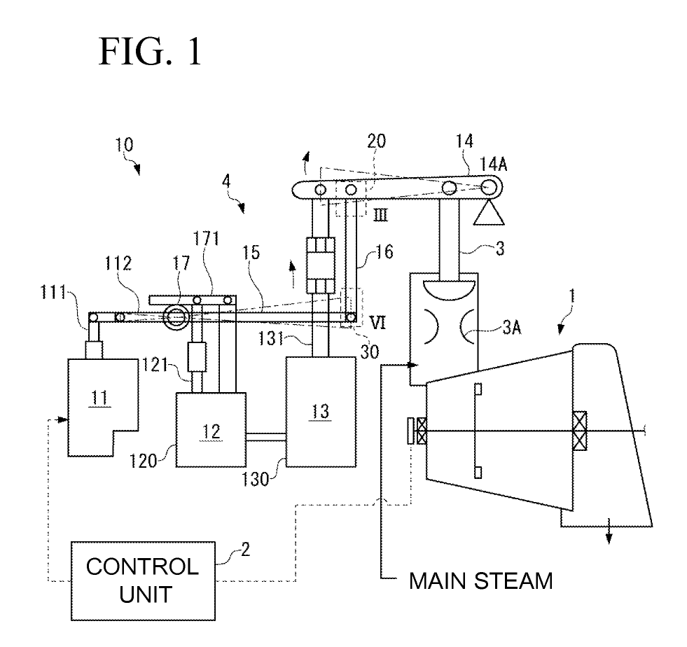

A steam turbine 1 (FIG. 1) uses steam supplied from a boiler (not shown) or the like to rotate blades and thus output power. An electronic control unit 2 (governor) of the steam turbine 1 basically sets an appropriate opening of a regulating valve 3 to control a rotational speed of the steam turbine 1. The steam turbine 1 includes the regulating valve 3 that regulates a flow rate of the steam to be supplied to the steam turbine 1, and also a stop valve (not shown) that blocks supply of the steam to the steam turbine 1.

### Regulating Valve Driving Device

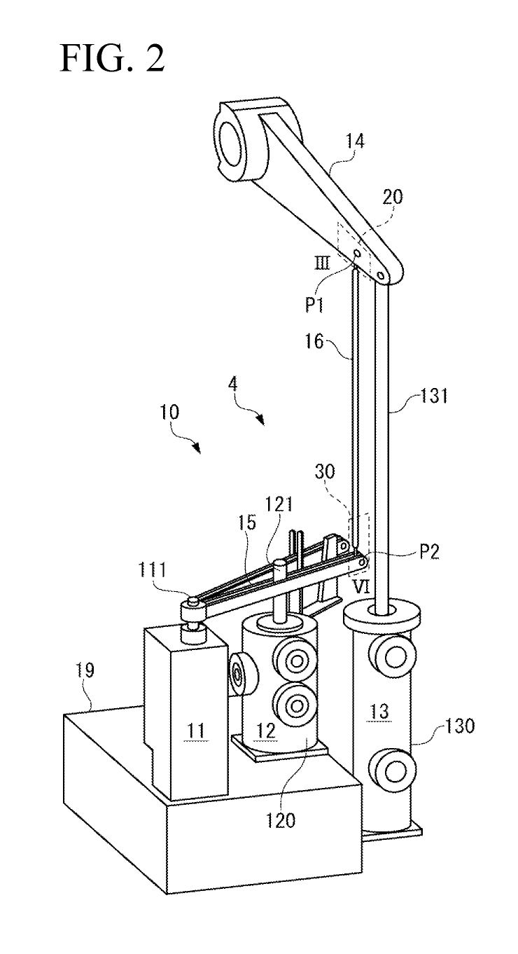

First, with reference to FIG. 1 and FIG. 2, a brief description will be made to a configuration and an effect of a regulating valve driving device 10 used for drive control of the steam turbine 1.

The regulating valve driving device 10 includes an actuator 11 with a motor, a pilot valve 12 and a servomotor 13 for obtaining oil pressure for driving the regulating valve 3 (FIG. 1), a regulating valve lever 14 connected to a piston 131 provided in the servomotor 13, and a feedback lever 15 that coordinates with the regulating valve lever 14.

In the example in FIG. 2, the regulating valve driving device 10 is provided on a cover 19 of a bearing of the steam turbine 1.

The components of the regulating valve driving device 10 are coupled by links (nodes). A plurality of links such as levers or rods of the regulating valve driving device 10 constitute a link mechanism 4 provided between the regulating valve 3 and the actuator 11.

The actuator 11 converts a rotational displacement of the motor into a linear displacement and outputs the linear displacement to an output shaft 111.

The pilot valve 12 includes a pilot cylinder 120 and a pilot piston valve 121 that vertically moves according to the output from the actuator 11, and supplies control oil below or above a servomotor piston 131 in a cylinder 130 of the servomotor 13 according to an operation of the pilot piston valve 121. The pilot valve 12 and the servomotor 13 are connected to a supply and discharge system (not shown) of the control oil.

The regulating valve lever 14 is rockable according to a lift amount with respect to a throttle hole 3A of the regulating valve 3, and pivotally supported on a member (not shown) at a position of a fulcrum 14A in FIG. 1. An extent of rocking of the regulating valve lever 14 according to an electric signal input to the actuator 11 is shown by dashed-dotted lines in FIG. 1. The same applies to the feedback lever 15 and a lever 112.

The feedback lever 15 is coupled to the regulating valve lever 14 via a rod 16, and connected to the pilot piston valve 121 on a side of a roller 17 as a fulcrum.

It is assumed that the control unit 2 (FIG. 1) inputs an electric signal to increase the opening of the regulating valve 3 (lift amount) to the actuator 11. In that case, a position of the output shaft 111 of the actuator 11 is lowered, and a position of the roller 17 connected to the output shaft 111 by the lever 112 is also lowered. Thus, the pilot piston valve 121 is pushed by a holding portion 171 holding the roller 17 and lowered.

Then, the pilot piston valve 121 is opened, and the control oil supplied to the pilot cylinder 120 flows into the cylinder 130 of the servomotor 13 below the servomotor piston 131. At this time, air is included above the servomotor piston 131 in the servomotor cylinder 130, and the oil pressure in the cylinder 130 raises the servomotor piston 131.

As the servomotor piston 131 is raised, the regulating valve lever 14 rocks upward around the fulcrum 14A (clockwise in FIG. 1). Simultaneously, as the rod 16 mounted to the regulating valve lever 14 is raised, the feedback lever 15 rocks upward around the output shaft 111 (counterclockwise in FIG. 1). The feedback lever 15 rocks until the pilot valve 12 returns to a neutral position, and the pilot piston valve 121 connected to the feedback lever 15 returns upward.

The configuration and effect of the regulating valve driving device 10 as described above allows the regulating valve 3 to operate according to the lift amount indicated by the electric signal generated by the control unit 2 such as a speed governor and provided to the actuator 11.

### Outline of Backup Device

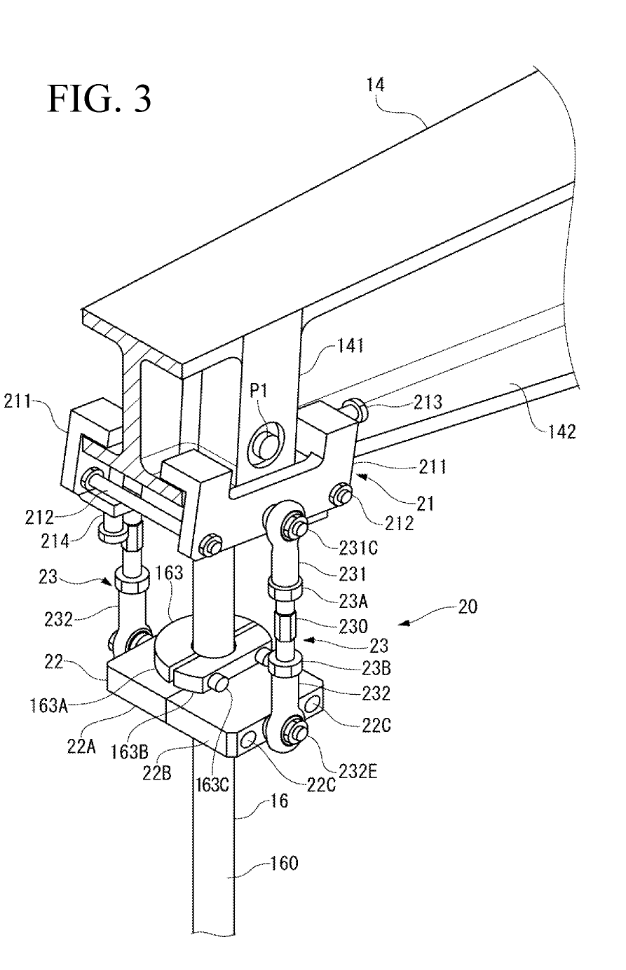

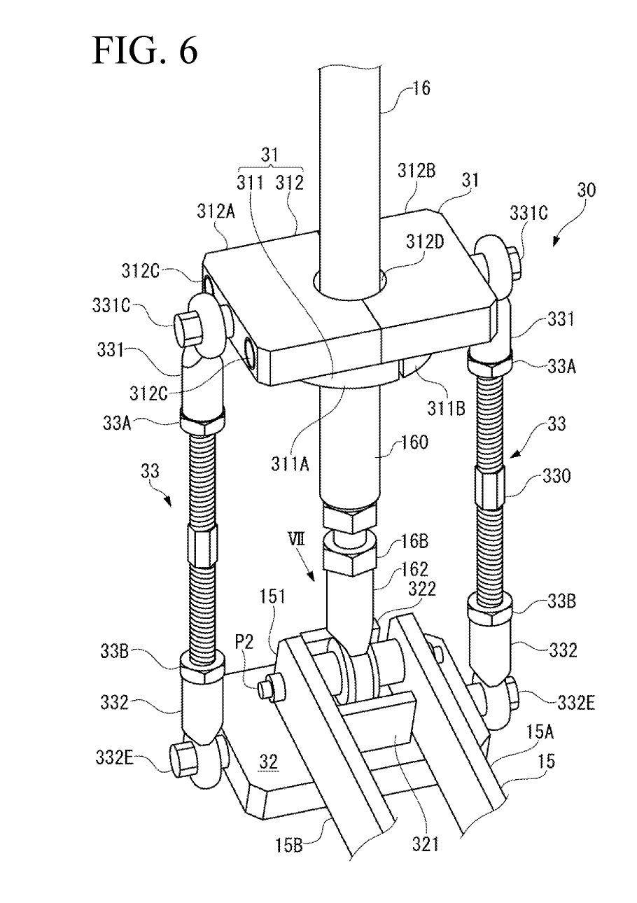

This embodiment is mainly characterized by including a backup device 20 (FIG. 3) and a backup device 30 (FIG. 6) that can replace joining of links to avoid an influence on the operation of the regulating valve 3 and further on the drive control of the steam turbine 1 even if a joint of the link mechanism 4 is damaged.

As described later, these backup devices 20, 30 may be added to the link mechanism 4 of the existing steam turbine 1.

As shown in FIG. 3, the backup device 20 located on an upper end side of the rod 16 corresponds to a section III shown by dashed lines in FIG. 1 and FIG. 2. The section III corresponds to a joining portion of the regulating valve lever 14 and the rod 16 and therearound.

As shown in FIG. 6, the backup device 30 located on a lower end side of the rod 16 corresponds to a section VI shown by dashed lines in FIG. 1 and FIG. 2. The section VI corresponds to a joining portion of the rod 16 and the feedback lever 15 and therearound.

The backup device 20 and the backup device 30 are added to the link mechanism 4, thereby ensuring a function of the link mechanism 4 even if the joint used for joining the links is damaged by wear or the like and the links are disjoined in the sections III and VI.

When the two links (the regulating valve lever 14 as a first link and the rod 16 as a second link) are disjoined, the upper backup device 20 (FIG. 3) replaces the joining of the links 14, 16. While the links are still safely joined, the backup device 20 does not replace the joining of the regulating valve lever 14 and the rod 16.

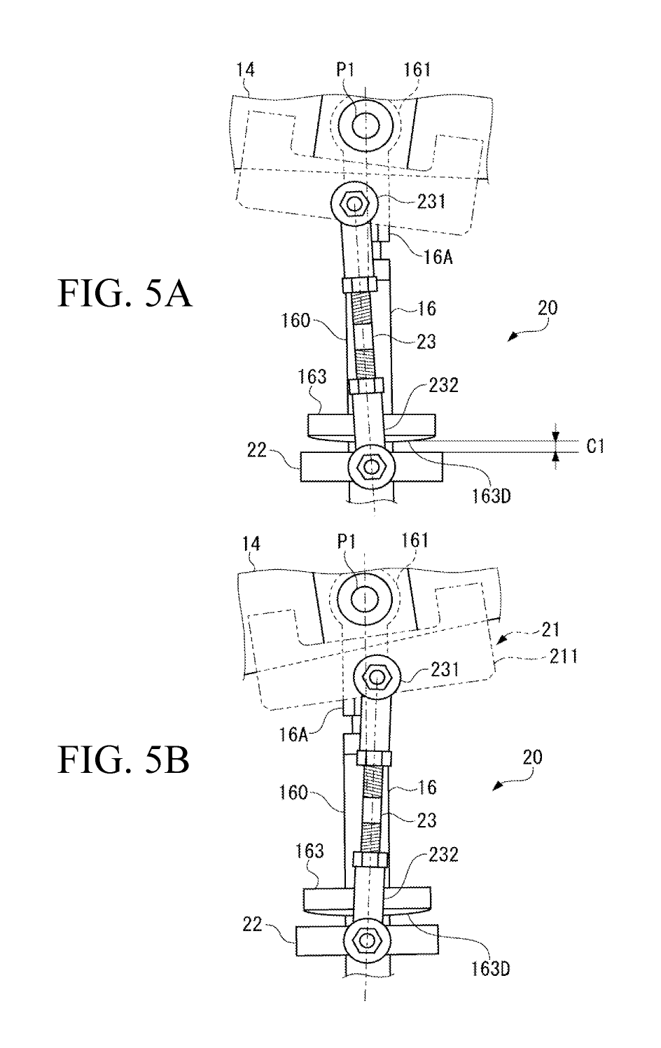

The rod 16 in this embodiment includes a tubular turn buckle 160 (FIG. 5) having a right thread on one end side and a left thread on the other end side and having an adjustable length, a rod end bearing 161 (FIG. 5) provided at an upper end of the turn buckle 160 by a securing nut 16A (FIG. 5), a rod end bearing 162 (FIG. 6) provided at a lower end of the turn buckle 160 by a securing nut 16B (FIG. 6), and a washer (not shown).

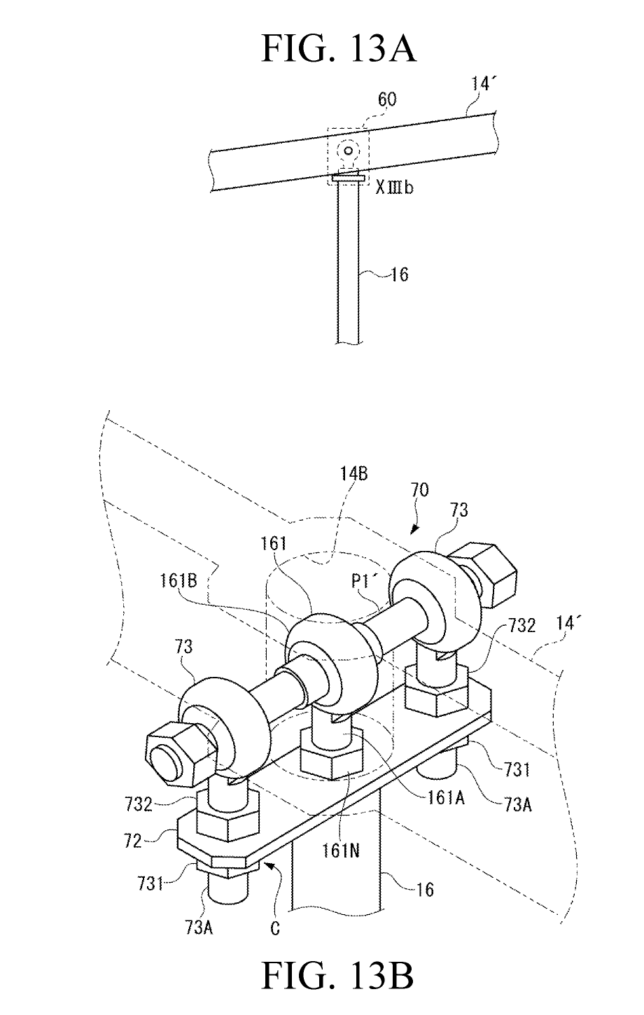

As shown in FIG. 3, the regulating valve lever 14 and the rod 16 are joined by a pin P1 (FIG. 3) inserted into the rod end bearing 161 (FIG. 5). The rod end bearing 161 is placed in an internal space (not shown) similar to a hole 14B in a regulating valve lever 14′ shown in FIG. 13B, in a thick portion 141 of the regulating valve lever 14. The pin P1 is placed in a width direction perpendicular to a length direction of the regulating valve lever 14 so as to extend through the rod end bearing 161 (FIG. 5) placed in the internal space and the regulating valve lever 14.

It is preferable that even if the joint (the pin P1 and the rod end bearing 161) that joins the regulating valve lever 14 and the rod 16 is damaged and the rod 16 is disengaged from the regulating valve lever 14, the upper end (the rod end bearing 161) of the rod 16 stays in the internal space of the regulating valve lever 14.

When the two links (the rod 16 as a first link and the feedback lever 15 as a second link) are disjoined, the lower backup device 30 (FIG. 6) also replaces joining of the links 16, 15. While the links are still safely joined, the backup device 30 does not replace the joining of the rod 16 and the feedback lever 15.

As shown in FIG. 6, the feedback lever 15 is joined to the lower rod end bearing 162 of the rod 16 by a pin P2. The pin P2 is placed in a width direction perpendicular to a length direction of the feedback lever 15.

As shown in FIG. 2, in this embodiment, an extending direction of the regulating valve lever 14 crosses an extending direction of the feedback lever 15. An axis line of the pin P2 provided in the feedback lever 15 crosses an axis line of the pin P1 provided in the regulating valve lever 14.

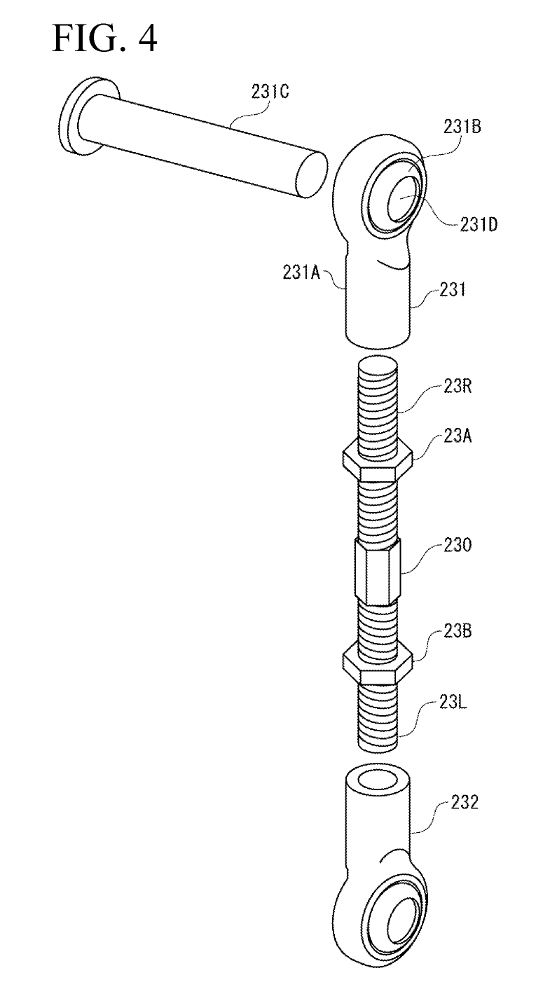

The rod end bearings 161, 162 are spherical bearings similar to rod end bearings 231, 232 shown in FIG. 4.

The joint using rod end bearings such as the rod end bearings 161, 162 can provide, between members to be joined, a degree of freedom in a direction around the axis of the pin and a degree of freedom in a rockable direction of a ball relative to a body of the rod end bearing.

It is preferable that the rod end bearings are used in the joining portions of the links so that the links of the link mechanism 4 are relatively smoothly displaced.

As described later, the backup devices 20, 30 each also includes a rod. To distinguish between the rods of the backup devices 20, 30 and the rod 16 that couples the regulating valve lever 14 and the feedback lever 15, the rod 16 will be hereafter referred to as “main rod 16”.

As shown in FIG. 1 and FIG. 2, an area from the regulating valve lever 14 through the main rod 16 to the feedback lever 15 corresponds to three links, and the two backup devices 20, 30 are provided in this area.

Now, configurations of the upper backup device 20 related to the regulating valve lever 14 as the first link and the main rod 16 as the second link, and the lower backup device 30 related to the main rod 16 as the second link and the feedback lever 15 as a third link will be described.

### Upper Backup Device

The upper backup device 20 (FIG. 3) is assembled to the regulating valve lever 14 and the main rod 16. The upper backup device 20 includes a clamp 21 (first support portion) as a support portion provided on the regulating valve lever 14, a first stand-by plate 22 (locking portion, first stand-by member) suspended from the clamp 21 and located immediately below a contact stopper 163 that forms a part of the main rod 16, and a pair of rods 23, 23 that suspend the first stand-by plate 22 from the clamp 21.

While the regulating valve lever 14 and the main rod 16 are joined, the upper backup device 20 is not involved in the operations of the link mechanism 4 and the regulating valve 3 because the first stand-by plate 22 is located away from a part (contact stopper 163) of the main rod 16.

However, if the regulating valve lever 14 and the main rod 16 are disjoined due to damage to the joint or the like, the main rod 16 is disengaged from the regulating valve lever 14, and the contact stopper 163 is supported by the first stand-by plate 22. Thus, the regulating valve lever 14 and the main rod 16 are engaged via the upper backup device 20 including the first stand-by plate 22 and the clamp 21. At this time, the upper backup device 20 replaces the joining of the regulating valve lever 14 and the main rod 16.

FIG. 3 and FIG. 5 show an example of the configuration of the upper backup device 20 having the effect described above. Now, specific configurations of the components of the upper backup device 20 will be described.

### Clamp

The clamp 21 includes a pair of clamp members 211, 211 that hold the regulating valve lever 14 from opposite sides in the width direction, and restraining members 212 such as bolts and nuts that restrain the pair of clamp members 211, 211 from opposite sides.

The pair of clamp members 211, 211 both have a substantially L-shaped section except for a portion corresponding to the thick portion 141 of the regulating valve lever 14, and are placed on lower flanges 142 of the regulating valve lever 14. The clamp members 211, 211 are fastened to each other at two positions below the regulating valve lever 14 by the restraining members 212 having bolts extending through the clamp members 211, 211.

The shape of the clamp members 211, 211 described above allows the pin P1 to be withdrawn from the thick portion 141 with the clamp members 211, 211 being secured to the regulating valve lever 14. If the pin P1 is withdrawn, the upper backup device 20 acts like when the pin P1 or the rod end bearing 161 is damaged. This allows the pin P1 to be exchanged during the operation of the steam turbine 1.

Also, each clamp member 211 is butted against a side wall of the thick portion 141 and fastened by a bolt 213, and fastened to the lower flange 142 of the regulating valve lever 14 from below by a bolt 214. Thus, the clamp 21 is secured to the regulating valve lever 14 so as not to move in the width direction of the regulating valve lever 14 and also in the length direction and a height direction (vertical direction) of the regulating valve lever 14.

### Rod

As shown in FIG. 3, the rods 23 are assembled to the pair of clamp members 211, 211, respectively, and extend downward substantially along the main rod 16 on opposite sides of the main rod 16. Each rod 23 is located radially away from the main rod 16, and thus does not interfere with the main rod 16 even if the regulating valve lever 14 rocks.

As shown in FIG. 4, each rod 23 includes a turn buckle 230 having a right thread 23R on one end side and a left thread 23L on the other end side and having an adjustable length, a rod end bearing 231 provided at one end (upper end) of the turn buckle 230 by a securing nut 23A, a rod end bearing 232 provided at the other end (lower end) of the turn buckle 230 by a securing nut 23B, and a washer (not shown).

The rod 23 including the turn buckle is easily adjusted in length so that the link smoothly moves.

A rod that does not include the turn buckle 230 or the rod end bearings 231, 232 may be used.

The rod end bearing 231 is a joint that connects the regulating valve lever 14 and the turn buckle 230, and a spherical bearing having a body 231A and a ball 231B as shown in FIG. 4. The ball 231B has a cylindrical hole 231D through which a pin 231C (FIG. 3 and FIG. 4) is inserted. A lubricating liner may be provided between a spherical slide surface on an outer periphery of the ball 231B and a slide surface on an inside of the body 231A following the spherical slide surface.

The rod end bearing 232 and rod end bearings 331, 332 of the backup device 30 described later are configured similarly to the rod end bearing 231 described above.

As shown in FIG. 3, the rod end bearing 231 is placed in a middle between the two restraining members 212, 212 that fasten the pair of clamp members 211, 211, on the outside of the clamp member 211. The rod 23 is assembled to the clamp 21 by the rod end bearing 231 and the pin 231C extending through the clamp member 211.

The pin 231C is placed in parallel with the pin P1 near (immediately below) the joint (the rod end bearing 161 and the pin P1) that joins the regulating valve lever 14 and the main rod 16.

Lengths of the rod 23 and the rod 33 of the backup device 30 described later are shorter than a length of the main rod 16. Thus, a natural frequency of each of the rod 23 and the rod 33 is different from a natural frequency of the main rod 16.

Thus, even if the rod end bearing or the pin located at the end of the main rod 16 is damaged due to resonance in the main rod 16 during the operation of the steam turbine 1, resonance occurring in the rods 23, 33 can be avoided to prevent damage to the rod end bearing or the pin related to the rods 23, 33.

### Contact Stopper (Contact Portion)

The contact stopper 163 (FIG. 3) is provided on an outer peripheral portion of the turn buckle 160 of the main rod 16 and thus integrated with the main rod 16.

The contact stopper 163 is split into two pieces so as to hold the turn buckle 160 from opposite sides in a diametrical direction of the turn buckle 160. Notches (not shown) in the outer peripheral portion of the turn buckle 160 are held between a semicircular first piece 163A and a substantially semicircular second piece 163B of the contact stopper 163, and the first piece 163A and the second piece 163B are fastened by a bolt 163C. Thus, the first piece 163A and the second piece 163B are secured to the outer peripheral portion of the main rod 16.

The first piece 163A and the second piece 163B are placed in the pair of notches (not shown) in the outer peripheral portion of the turn buckle 160, thereby preventing the contact stopper 163 from shifting downward. The same applies to split pieces of a support stopper 311 (FIG. 6) described later.

If the main rod 16 includes a portion that faces an upper surface of the first stand-by plate 22 and can come into contact with the first stand-by plate 22 when the main rod 16 is disengaged from the regulating valve lever 14, for example, a large diameter portion that faces the upper surface of the first stand-by plate 22, the portion can replace the contact stopper 163, thereby eliminating the need for the contact stopper 163. The portion that can come into contact with the first stand-by plate 22 does not always need to be placed entirely around the main rod 16.

The support stopper 311 described later can be also replaced by an appropriate portion provided in the main rod 16, if any.

As shown in FIG. 5, the contact stopper 163 preferably has a spherical contact surface 163D protruding toward the first stand-by plate 22.

The contact surface 163D comes into contact with the first stand-by plate 22 if the main rod 16 is disengaged from the regulating valve lever 14 by its own weight when the regulating valve lever 14 and the main rod 16 are disjoined, for example, due to damage to the rod end bearing 161 or the pin P1.

When the contact stopper 163 comes into contact with the first stand-by plate 22, the spherical contact surface 163D contributes to an increase in a degree of freedom between the main rod 16 to which the contact stopper 163 is secured and the regulating valve lever 14 provided with the clamp 21 from which the first stand-by plate 22 is suspended.

### Stand-by Plate

The first stand-by plate 22 (FIG. 3 and FIG. 5) is placed immediately below the contact stopper 163. The first stand-by plate 22 is placed below a part (contact stopper 163) of the main rod 16 with a gap from the part.

The first stand-by plate 22 receives the contact stopper 163 that forms the part of the main rod 16 disengaged from the regulating valve lever 14 due to damage to the joint or the like. At this time, the contact stopper 163 is locked in contact with the first stand-by plate 22 to prevent the main rod 16 from moving further downward.

As shown in FIG. 3, the first stand-by plate 22 is suspended from the regulating valve lever 14 via the clamp 21 by the pair of rods 23 with stability in position. The first stand-by plate 22 is assembled to the lower rod end bearings 232 of the rods 23 by pins 232E (FIG. 3). The first stand-by plate 22 and the pair of rods 23 are entirely suspended from the regulating valve lever 14 via the clamp 21.

The first stand-by plate 22 is placed around the outer peripheral portion of the turn buckle 160 of the main rod 16. Unlike the contact stopper 163 described above, there is a gap between the outer peripheral portion of the turn buckle 160 and the first stand-by plate 22, and thus the first stand-by plate 22 does not restrain the main rod 16.

Like the contact stopper 163, the first stand-by plate 22 may include two split pieces on the opposite sides of the turn buckle 160 in the diametrical direction.

The first stand-by plate 22 of this embodiment includes substantially rectangular flat half-split bodies 22A, 22B.

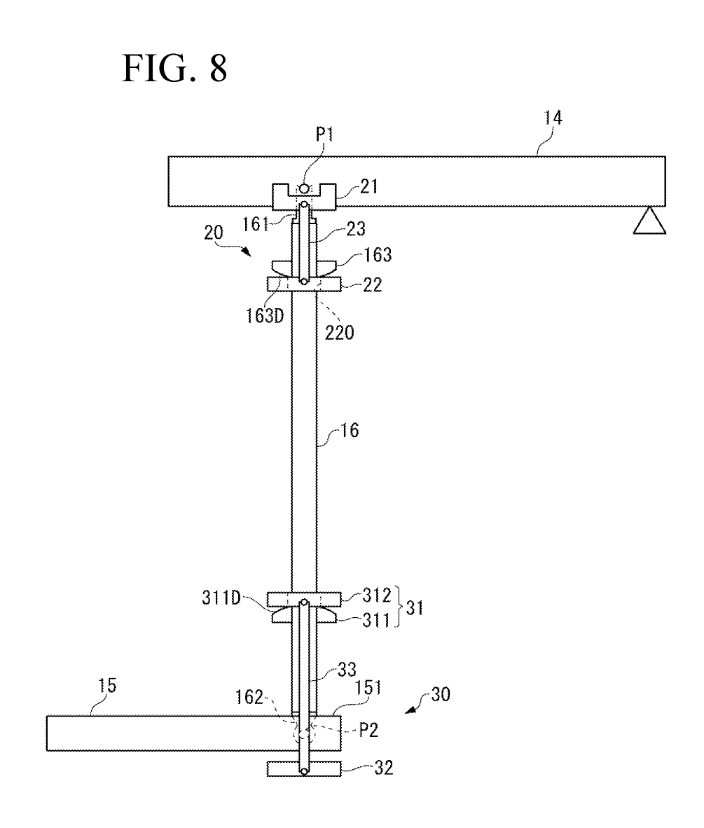

The half-split bodies 22A, 22B are fastened by a bolt 22C with the turn buckle 160 being held therebetween. A hole 220 (FIG. 8) through which the turn buckle 160 is placed is formed between the half-split bodies 22A, 22B. A diameter of the hole 220 is larger than an outer diameter of the turn buckle 160.

As shown in FIG. 5A corresponding to a maximum opening of the regulating valve 3 and FIG. 5B corresponding to a minimum opening thereof, the positions of the regulating valve lever 14 and the main rod 16 are changed according to the opening of the regulating valve 3, and a dimension of the gap between the contact stopper 163 and the first stand-by plate 22 is also changed.

Thus, while the regulating valve lever 14 and the main rod 16 are safely joined (normal time), an appropriate clearance C1 that can avoid a contact between the contact stopper 163 and the first stand-by plate 22 is provided between the contact surface 163D of the contact stopper 163 and a flat upper surface of the first stand-by plate 22 located immediately below the contact surface 163D. The clearance C1 may be determined in view of vibration displacement transmitted from the bearing or the like of the steam turbine 1 to the upper backup device 20 via the regulating valve driving device 10 provided near the bearing.

A large clearance C1 increases an amount of shift when the main rod 16 is disengaged from the regulating valve lever 14 as compared to before the links of the regulating valve lever 14, the main rod 16, and the feedback lever 15, or the like are disengaged. Thus, the clearance C1 is preferably determined to the extent that the operations of the links are not hindered.

The clearance C1 can prevent an influence on the operations of the links of the link mechanism 4 in normal time.

Relative displacement and contact between the contact stopper 163 and the first stand-by plate 22 due to disturbance are not excluded.

Like a positional relationship between the contact stopper 163 and the first stand-by plate 22, an appropriate clearance that can avoid contact between the first stand-by plate 22 and the turn buckle 160 may be also set between a peripheral edge of the hole 220 (FIG. 8) in the center of the first stand-by plate 22 and the outer peripheral portion of the turn buckle 160. Then, the turn buckle 160 can smoothly move through the hole 220 in the first stand-by plate 22 as the regulating valve lever 14 rocks.

### Lower Backup Device

Next, as shown in FIG. 6, the lower backup device 30 assembled to the main rod 16 and the feedback lever 15 will be described.

The lower backup device 30 includes a support stopper 311 provided on the outer peripheral portion of the main rod 16, a joining plate 312 supported on the support stopper 311, a second stand-by plate 32 suspended from the joining plate 312 and located immediately below a front end 151 of the feedback lever 15, and a pair of rods 33, 33 that suspend the second stand-by plate 32 from the joining plate 312.

The lower backup device 30 includes a support portion (second support portion) including the support stopper 311 and the joining plate 312, and the second stand-by plate 32 as a second stand-by member.

While the main rod 16 and the feedback lever 15 are joined, the lower backup device 30 is not involved in the operations of the link mechanism 4 and the regulating valve 3 because the second stand-by plate 32 is located away from the front end 151 of the feedback lever 15.

However, if the main rod 16 and the feedback lever 15 are disjoined due to damage to the joint or the like, the feedback lever 15 is disengaged from the main rod 16 by its own weight, and the front end 151 is supported by the second stand-by plate 32. Thus, the main rod 16 and the feedback lever 15 are engaged via the lower backup device 30 including the second stand-by plate 32 and the support portion 31. At this time, the lower backup device 30 replaces the joining of the main rod 16 and the feedback lever 15.

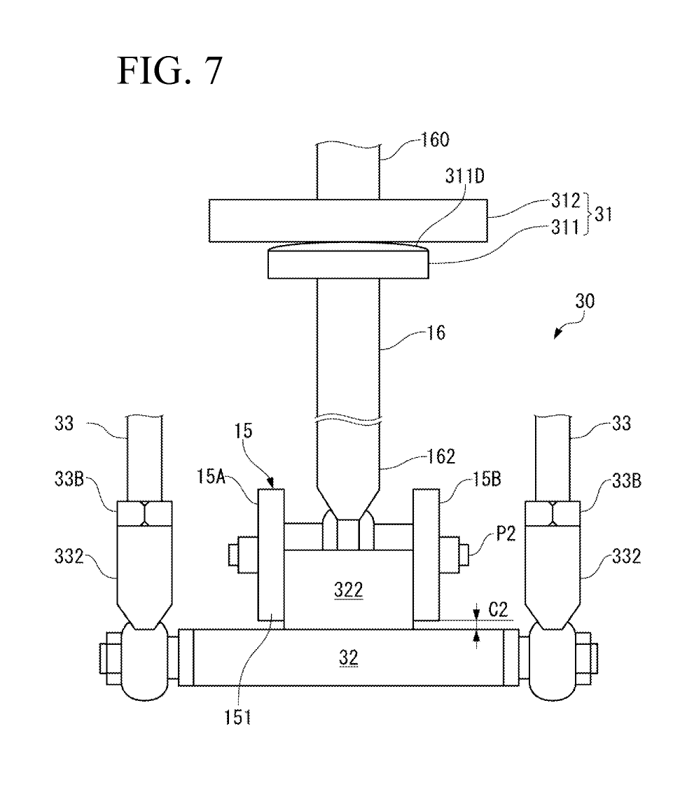

FIG. 6 and FIG. 7 show an example of a configuration of the lower backup device 30 having the effect described above. Now, specific configurations of the components related to the lower backup device 30 will be described.

### Support Stopper

The support stopper 311 is secured to a predetermined position in the length direction of the main rod 16.

Like the contact stopper 163 described above, the support stopper 311 includes a first piece 311A and a second piece 311B. The first piece 311A and the second piece 311B are fastened by a bolt (not shown) with notches (not shown) in the outer peripheral portion of the turn buckle 160 of the main rod 16 being held therebetween.

In this embodiment, an upper end of the rod 33 is assembled to the joining plate 312 rather than the support stopper 311 for the following reason.

Assembling a rod end bearing 331 to the support stopper 311 by a pin 331C without the joining plate 312 is related to the fact that a phase around an axis of the turn buckle 160 of the main rod 16 is not constant due to an assembly tolerance or the like of the main rod 16. If the phase around the axis of the turn buckle 160 were within an extent that assembling of the rod 33 is not hindered, the rod end bearing 331 could be assembled to the support stopper 311.

Actually, the phase around the axis of the turn buckle 160 cannot be predicted due to the assembly tolerance or the like, and thus phases of the notches formed in the outer peripheral portion of the turn buckle 160 (positions of the pair of notches in a direction around the axis of the rod) cannot be predicted either.

On the other hand, phases of the pair of rods 33, 33 are determined by a configuration in which the rods 33, 33 are placed on the opposite sides of the feedback lever 15 in the width direction to suspend the stand-by plate 32. The pin 331C inserted into the upper end of each rod 33 is placed in parallel with the pin P2.

If the position of the pin 331C matches a boundary between the first piece 311A and the second piece 311B placed to hold the turn buckle 160 therebetween according to the position of the notches due to the phase of the turn buckle 160, the rod end bearing 331 cannot be assembled to the support stopper 311.

To eliminate the restriction on assembling of the rod 33 as described above, the support portion 31 includes the two members of the support stopper 311 and the joining plate 312 as in this embodiment.

As shown in FIG. 7, the support stopper 311 preferably has a spherical support surface 311D protruding toward the joining plate 312.

The support surface 311D contributes to an increase in a degree of freedom between the main rod 16 provided with the support stopper 311 and the joining plate 312 and the feedback lever 15 supported by the second stand-by plate 32.

### Joining Plate

The joining plate 312 is placed around the outer peripheral portion of the turn buckle 160 above the support stopper 311 and supported from below by the support stopper 311.

Like the first stand-by plate 22 described above, the joining plate 312 may include two split pieces.

Substantially rectangular flat half-split bodies 312A, 312B of the joining plate 312 are fastened by a bolt 312C with the turn buckle 160 being held therebetween. A hole 312D through which the turn buckle 160 is placed is formed between the half-split bodies 312A, 312B. A diameter of the hole 312D is larger than an outer diameter of the turn buckle 160.

### Rod

As shown in FIG. 6, the rods 33 are assembled to the half-split bodies 312A, 312B of the joining plate 312 and extend downward substantially along the main rod 16 on the opposite sides of the main rod 16.

Each rod 33 is configured similarly to the rod 23 in FIG. 4. Specifically, the rod 33 also includes a turn buckle 330, a rod end bearing 331 provided at one end (upper end) of the turn buckle 330 by a securing nut 33A, a rod end bearing 332 provided at the other end (lower end) of the turn buckle 330 by a securing nut 33B, and a washer (not shown).

The rod 33 is assembled to the joining plate 312 by the pin 331C inserted into the rod end bearing 331.

### Second Stand-By Plate

The rectangular second stand-by plate 32 of the lower backup device 30 is placed immediately below near a joining portion of the main rod 16 and the feedback lever 15 (the front end 151 here) with a gap from the front end 151.

The second stand-by plate 32 receives the front end 151 of the feedback lever 15 disengaged from the main rod 16 due to damage to the joint or the like.

The second stand-by plate 32 is suspended from the joining plate 312 by the pair of rods 33. The second stand-by plate 32 is assembled to the lower rod end bearings 332 of the rods 33 by pins 332E. The second stand-by plate 32 and the pair of rods 33 are entirely suspended from the main rod 16 via the joining plate 312 and the support stopper 311.

The pin 332E is placed in parallel with the pin P2 near the joint (the rod end bearing 162 and the pin P2) that joins the main rod 16 and the feedback lever 15.

The pin 332E located in the lower end of the rod 33 is located below the pin P2. On the other hand, in the upper backup device 20 described above, the pin 231C located in the upper end of the rod 23 is located below the pin P1 so as to extend through the clamp members 211, 211 placed to allow the pin P1 to be withdrawn. Comparing the rod 23 of the upper backup device 20 with the rod 33 of the lower backup device 30 in view of such a configuration, the rod 23 is relatively short and the rod 33 is relatively long.

A pair of walls 321, 322 rise from an upper surface of the second stand-by plate 32. Between the pair of lever members 15A, 15B of the feedback lever 15, the rod end bearing 162 at the lower end of the main rod 16 is placed between the walls 321, 322 rising from the second stand-by plate 32.

It is preferable that even if the joint that joins the rod 16 and the feedback lever 15 is damaged and the feedback lever 15 is disengaged from the main rod 16, the lower end (rod end bearing 162) of the main rod 16 stays in a space surrounded by the walls 321, 322 and the lever members 15A, 15B.

As shown in FIG. 7, while the main rod 16 and the feedback lever 15 are safely joined, an appropriate clearance C2 that can avoid contact between the front end 151 and the second stand-by plate 32 is provided between the front end 151 of the feedback lever 15 and the upper surface of the second stand-by plate 32. The clearance C2 may be set similarly to the clearance C1 between the contact stopper 163 and the first stand-by plate 22 described above.

### Description on Backup Function of Backup Device

Damage to the joint or the like due to vibration, impact, or aged deterioration may disjoin the links.

As shown in FIG. 8, if damage to the pin P1 or the rod end bearing 161 (FIG. 4) occurs and the main rod 16 is disengaged from the regulating valve lever 14, the main rod 16 is disengaged by its own weight. Then, the contact stopper 163 secured to the main rod 16 is displaced by a distance of the clearance C1 to the first stand-by plate 22 suspended form the regulating valve lever 14 by the clamp 21, and supported by the first stand-by plate 22 immediately after the main rod 16 is disengaged.

Then, based on engagement between the contact stopper 163 and the first stand-by plate 22 supporting the contact stopper 163, the main rod 16 provide with the contact stopper 163 and the regulating valve lever 14 provided with the clamp 21 that suspends the first stand-by plate 22 are joined via the upper backup device 20. Specifically, joining of the regulating valve lever 14 and the main rod 16 by the pin P1 and the rod end bearing 161 is switched to joining of the regulating valve lever 14 and the main rod 16 by the backup device 20.

Between the clamp 21 of the upper backup device 20 and the first stand-by plate 22 that has come into contact with the contact stopper 163, a degree of freedom is provided based on joining by the pin 231C and the rod end bearing 231 (FIG. 3) located near the pin P1 and joining by the rod end bearing 232 and the pin 232E on a lower end side of the rod 23. A degree of freedom corresponding thereto is also provided between the regulating valve lever 14 provided with the clamp 21 and the main rod 16 provided with the contact stopper 163 supported by the first stand-by plate 22.

Further, since only a part of the spherical contact surface 163D comes into contact with the first stand-by plate 22, friction between the contact stopper 163 and the first stand-by plate 22 can be reduced to allow changes in position of the contact stopper 163 relative to the upper surface of the first stand-by plate 22 with the contact stopper 163 and the first stand-by plate 22 being in contact.

Thus, the spherical contact surface 163D increases the degree of freedom between the regulating valve lever 14 and the main rod 16.

The same advantage as described above can be obtained if at least one of the contact surface 163D and the upper surface of the first stand-by plate 22 has a spherical shape.

The front end 151 of the feedback lever 15 joined to the main rod 16 by the pin P2 and the lower backup device 30 suspended from the support portion 31 (the support stopper 311 and the joining plate 312) provided on the main rod 16 are also slightly displaced downward by the distance of the clearance C1 that has existed between the contact stopper 163 and the first stand-by plate 22 before the main rod 16 is disengaged.

Similarly to the upper backup device 20, also between the support portion 31 of the lower backup device 30, the rod 33, and the second stand-by plate 32, a degree of freedom is provided based on joining by the rod end bearings 331, 332 and the pins corresponding thereto. The link joining in the lower backup device 30 also provides a degree of freedom between the main rod 16 provided with the support portion 31 and the feedback lever 15 supported by the second stand-by plate 32.

Further, similarly to the spherical contact surface 163D described above, the spherical support surface 311D of the support stopper 311 increases the degree of freedom between the main rod 16 and the feedback lever 15.

The same advantage as described above can be obtained if at least one of the support surface 311D and the lower surface of the joining plate 312 has a spherical shape.

From the above, even after the backup device 20 replaces the joining of the regulating valve lever 14 and the main rod 16, substantially the same degree of freedom as before the replacement is ensured between the links including the regulating valve lever 14, the main rod 16, and the feedback lever 15.

Specifically, even if the links including the regulating valve lever 14, the main rod 16, and the feedback lever 15 are relatively displaced as the main rod 16 is disengaged by the distance of the clearance C1, a sufficient degree of freedom that absorbs the relative displacement between the links and covers a movable range of the link mechanism 4 from the minimum opening to the maximum opening of the regulating valve 3 is ensured by the link joining in the backup devices 20, 30. Thus, even after the upper backup device 20 replaces the pin P1 and the rod end bearing 161, the function of the link mechanism 4 can be ensured while the displacement is transmitted from the regulating valve lever 14 via the main rod 16 to the feedback lever 15. Specifically, the operation of the steam turbine 1 can be continued while the opening of the regulating valve 3 is controlled via the link mechanism 4.

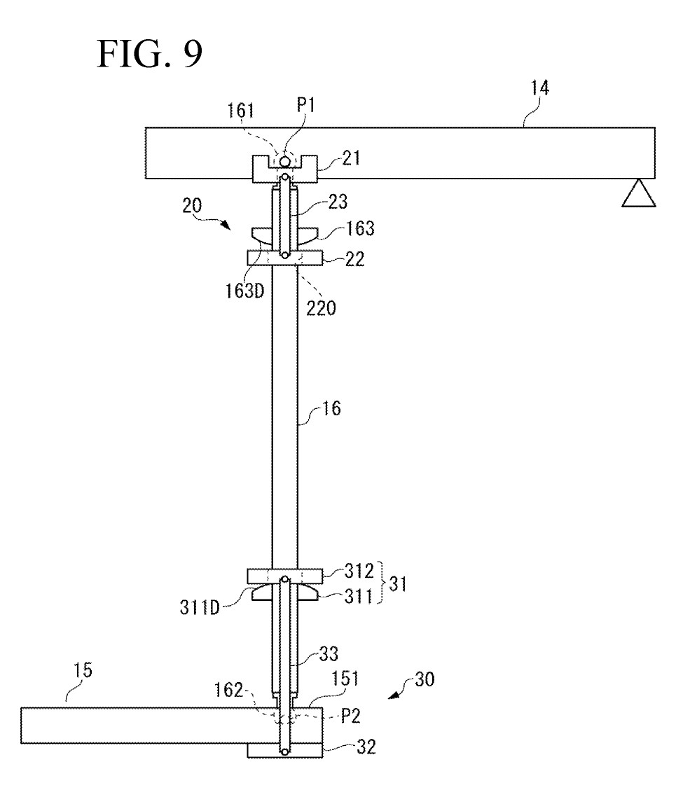

Next, with reference to FIG. 9, a case where damage to the pin P2 or the rod end bearing 162 (FIG. 6) located at the lower end of the main rod 16 occurs will be described.

In this case, if the feedback lever 15 is disengaged from the main rod 16 by its own weight, the lower backup device 30 joins the main rod 16 and the feedback lever 15.

At this time, the front end 151 of the feedback lever 15 is displaced by the distance of the clearance C2 to the second stand-by plate 32 suspended from the joining plate 312 and supported by the second stand-by plate 32.

Then, based on engagement between the front end 151 of the feedback lever 15 and the second stand-by plate 32 supporting the front end 151, the feedback lever 15 and the main rod 16 that suspends the second stand-by plate 32 from the support portion 31 are joined via the lower backup device 30.

On the upper end side of the main rod 16, the upper backup device 20 is still suspended from the regulating valve lever 14 joined to the main rod 16 by a safe joint. At this time, it is preferable that the contact stopper 163 is not in contact with the first stand-by plate 22.

Also when the lower backup device 30 operates, substantially the same degree of freedom as before the lower backup device 30 operates is ensured between the links including the regulating valve lever 14, the main rod 16, the feedback lever 15 based on the joining by the pins and the rod end bearings at the opposite ends of the rod 23 provided in the upper backup device 20 or the rod 33 provided in the lower backup device 30 and the spherical support surface 311D being formed on the support stopper 311.

Specifically, even if the links including the regulating valve lever 14, the main rod 16, and the feedback lever 15 are relatively displaced as the feedback lever 15 is disengaged by the distance of the clearance C2, a sufficient degree of freedom that absorbs the relative displacement between the links and covers a movable range of the link mechanism 4 from the minimum opening to the maximum opening of the regulating valve 3 is ensured by the link joining in the backup devices 20, 30. Thus, the lower backup device 30 can join the main rod 16 and the feedback lever 15, and the operation of the steam turbine 1 can be continued while the function of the link mechanism 4 is ensured and the opening of the regulating valve 3 is controlled.

The steam turbine 1 including both the upper backup device 20 and the lower backup device 30 as in this embodiment can achieve backup of the link mechanism 4 both even when the upper end of the main rod 16 and the regulating valve lever 14 are disjoined and even when the lower end of the main rod 16 and the feedback lever 15 are disjoined.

However, only the upper backup device 20 may be provided in the steam turbine 1 in preparation for disjoining at the upper end of the main rod 16, or only the lower backup device 30 may be provided in preparation for disjoining at the lower end of the main rod 16.

### Method for Modifying Existing Steam Turbine

Next, a method for modifying the steam turbine 1 that has a backup function that can replace the link joining in the link mechanism 4 by adding the backup devices 20, 30 to the existing steam turbine will be described.

Examples of procedures for adding the upper backup device 20 (FIG. 3) and the lower backup device 30 (FIG. 6) will be described below. Both for the upper backup device 20 and the lower backup device 30, a locking structure adding step including the following procedures is performed.

### Adding Upper Backup Device (FIG. 3)

(1) The clamp members 211, 211 of the clamp 21 are secured to the regulating valve lever 14 (a clamp providing step).

(2) The first piece 163A and the second piece 163B of the contact stopper 163 are placed on the opposite sides of the turn buckle 160 of the main rod 16 in the diametrical direction, and the first piece 163A and the second piece 163B are fastened. Thus, the contact stopper 163 is secured to the outer peripheral portion of the main rod 16 (a contact stopper providing step).

(3) The upper ends of the rods 23 are mounted to the clamp members 211, 211 by the pins 231C (a rod mounting step).

(4) The half-split body 22A of the first stand-by plate 22 is mounted to the lower end of one rod 23 by the pin 232E, and the half-split body 22B is mounted to the lower end of the other rod 23 by the pin 232E. The half-split bodies 22A, 22B are suspended from the clamp 21 by the rods 23.

(5) The turn buckle 160 is held between the half-split bodies 22A, 22B and the half-split bodies 22A, 22B are fastened to assemble the first stand-by plate 22. Then, the first stand-by plate 22 suspended from the clamp 21 is placed immediately below the contact stopper 163 and around the turn buckle 160 (the items (4) and (5) above correspond to an immediately-below placing step).

By the above, adding of the upper backup device 20 to the existing steam turbine is completed.

### Adding of Lower Backup Device (FIG. 6)

(1) The turn buckle 160 of the main rod 16 is held between the first piece 311A and the second piece 311B of the support stopper 311, and the first piece 311A and the second piece 311B are fastened. Thus, the support stopper 311 is secured to the outer peripheral portion of the main rod 16.

(2) On the support stopper 311, the turn buckle 160 is held between the half-split bodies 312A, 312B of the joining plate 312, and the half-split bodies 312A, 312B are fastened. Thus, the joining plate 312 is supported on the support stopper 311 (the items (1) and (2) above correspond to a support portion providing step).

(3) The upper ends of the rods 33 are mounted to the half-split bodies 312A, 312B of the joining plate 312 by the pins 331C (a rod mounting step).

(4) The second stand-by plate 32 is mounted to the lower ends of the pair of rods 33,33 below the feedback lever 15 by the pins 332E. Then, the second stand-by plate 32 suspended from the joining plate 312 is placed immediately below the feedback lever 15 (an immediately-below placing step).

By the above, adding of the lower backup device 30 to the existing steam turbine is completed.

By the procedures for adding the backup devices 20, 30 described above, the contact stopper 163, the first stand-by plate 22, the support stopper 311, and the joining plate 312 are members that can be assembled around the main rod 16, and thus there is no need for an operation for inserting the main rod 16 through an annular member. Thus, the backup devices 20, 30 can be installed in the existing links without a need to disassemble the links such as to remove the pin P1 or the pin P2 to disengage the main rod 16 from the regulating valve lever 14 or the feedback lever 15. Thus, a modifying operation for adding the backup devices 20, 30 can be performed while driving of the regulating valve 3 is controlled via the link mechanism 4 without stopping the operation of the existing steam turbine.

### For Newly Produced Steam Turbine

The steam turbine 1 including the backup devices 20, 30 may be newly produced, not limited to the addition of the backup devices 20, 30 by modifying the existing steam turbine as described above.

In that case, the upper ends of the rods 23 are mounted to the regulating valve lever 14 by the pins 231C, and the rods 23 can suspend the first stand-by plate 22 from the regulating valve lever 14. Thus, there is no need for the clamp 21.

Depending on the order of assembly of the components of the main rod 16, the regulating valve lever 14, the feedback lever 15, and the backup device 20, there is no need for the first stand-by plate 22 or the contact stopper 163 to be split.

This also applies to the support stopper 311 or the joining plate 312 of the lower backup device 30.

### First Variant

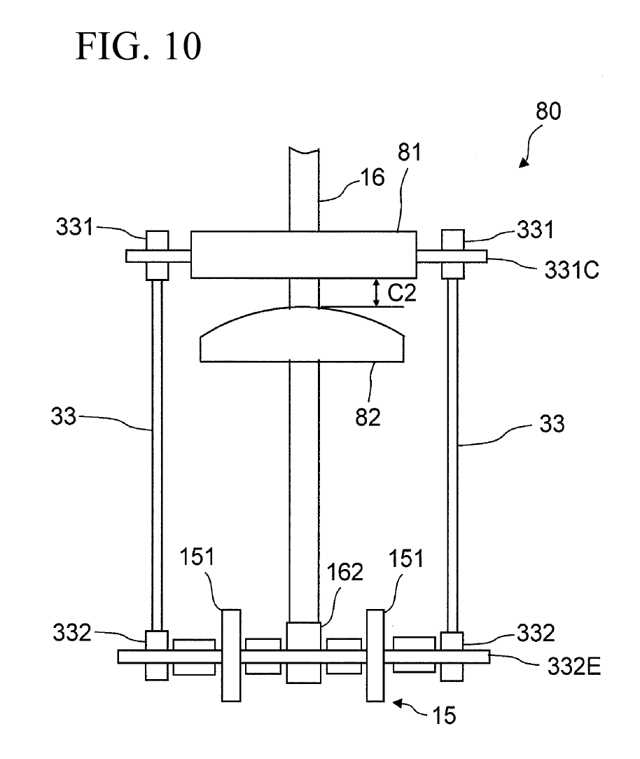

FIG. 10 shows a lower backup device 80 according to a first variant of the present disclosure.

The same components as those in the embodiment described above are denoted by the same reference signs.

In the first variant, a joining plate 81 is supported in an upper position via rods 33 by a pin P2 having an increased length, and the joining plate 81 is locked by a stopper 82 when a feedback lever 15 is disengaged from a main rod 16.

Specifically, in the first variant, the joining plate 81 corresponds to a contact portion and the stopper 82 corresponds to a locking portion. A clearance C2 is set between the joining plate 81 and the stopper 82. The joining plate 81 may be configured similarly to the joining plate 312 in the embodiment described above (FIG. 6). The stopper 82 may be also configured similarly to the support stopper 311 in the embodiment described above (FIG. 6).

### Second Variant

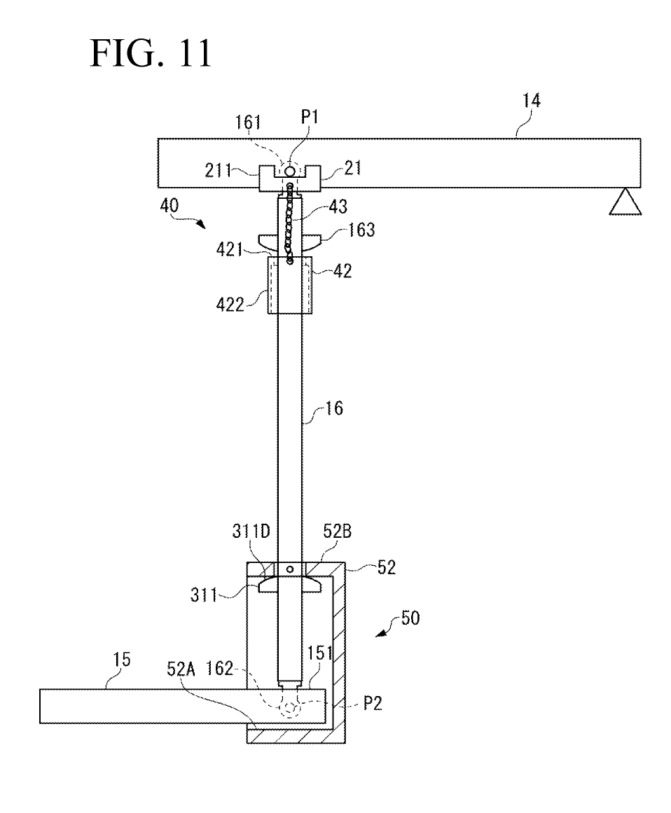

FIG. 11 shows an upper backup device 40 and a lower backup device 50 according to a second variant of the present disclosure.

The upper backup device 40 is different from the upper backup device 20 in the embodiment described above mainly in that a pair of chains 43 instead of the pair of rods 23 are used to suspend a stand-by member 42.

The upper backup device 40 includes a clamp 21, the stand-by member 42, and the pair of chains 43 (only one is shown).

The chains 43 are mounted to clamp members 211, 211 secured to a regulating valve lever 14 and support the stand-by member 42.

The stand-by member 42 includes a stand-by portion 421 located immediately below a contact stopper 163 secured to a main rod 16, and a wall 422 that surrounds an outer peripheral portion of the main rod 16 and prevents positional displacement of the stand-by portion 421.

The upper backup device 40 operates similarly to the upper backup device 20 in the embodiment described above.

The lower backup device 50 includes a support stopper 311 secured to the main rod 16, and a box-like stand-by member 52 that is suspended from the support stopper 311 and has a stand-by portion 52A located immediately below a front end 151 of a feedback lever 15. A lower surface of an upper wall 52B of the stand-by member 52 is supported by the support stopper 311, and the stand-by member 52 is entirely suspended from the support stopper 311.

A support surface 311D of the support stopper 311 has a spherical shape, and thus the stand-by member 52 is preferably rockable while being supported by the support stopper 311.

The stand-by member 52 and the stand-by member 42 described above are preferably split so that they can be also mounted to the existing main rod 16.

The lower backup device 50 operates similarly to the lower backup device 30 in the embodiment described above.

Similarly to the embodiment described above, the second variant can provide redundancy to a link mechanism 4.

### Third Variant

The backup devices 20, 30, 40, 50 described above all replace the joining of the two links directly joined. For example, the upper backup device 20 replaces the joining of the regulating valve lever 14 as the first link and the main rod 16 as the second link.

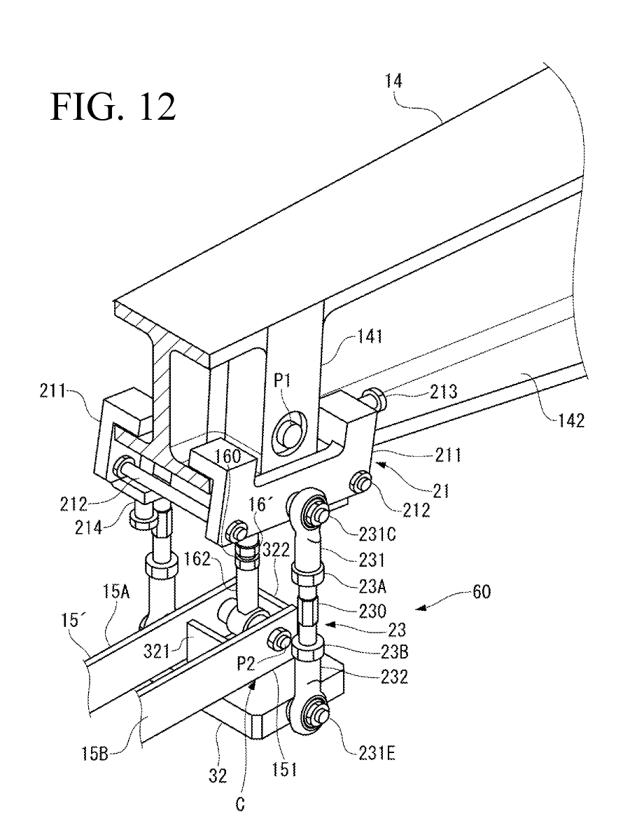

On the other hand, a backup device 60 according to a third variant of the present disclosure in FIG. 12 is assembled to a first link (regulating valve lever 14) and a second link (feedback lever 15′) via an intermediate link (main rod 16′) to replace both joining of the first link 14 and the intermediate link 16′ and joining of the intermediate link 16′ and the second link 15′.

Specifically, the backup device 60 serves as both the upper backup device 20 and the lower backup device 30.

A length of the main rod 16′ in FIG. 12 is shorter than the length of the main rod 16 in the embodiment described above. However, the main rod 16′ may have any length as long as a degree of freedom can be ensured between the links to the extent that movement of a link mechanism 4 is not hindered after the joint is damaged.

The backup device 60 includes a clamp 21 secured to the regulating valve lever 14, a stand-by plate 32 located immediately below a front end 151 of a feedback lever 15, and a pair of rods 23 that suspend the stand-by plate 32 from the clamp 21.

The backup device 60 does not include members corresponding to the contact stopper 163 and the stand-by plate 22, or the support stopper 311 and the joining plate 312.

If the main rod 16′ is disengaged from the regulating valve lever 14 due to damage to a pin P1, a rod end bearing 161, or the like, the main rod 16′ is displaced by its own weight by a distance of a clearance C set between the stand-by plate 32 and the front end 151 of the feedback lever 15. Thus, the front end 151 of the feedback lever 15 joined to a lower end of the main rod 16′ is locked by the stand-by plate 32. Also thereafter, an operation of a steam turbine 1 can be continued while the link mechanism 4 is normally operated because of a degree of freedom provided by the link joining in the backup device 60.

Also, if the feedback lever 15 is disengaged from the main rod 16′ due to damage to a pin P2, a rod end bearing 162, or the like, or if a shaft of a turn buckle 160 of the main rod 16′ or the like is broken, similarly to the above, the front end 151 of the feedback lever 15 is locked by the stand-by plate 32, and thus the operation of the steam turbine 1 can be continued while the link mechanism 4 is normally operated.

### Fourth Variant

FIG. 13A and FIG. 13B show a regulating valve lever 14′ as a first link and a rod 16 as a second link.

As shown in FIG. 13B, a rod end bearing 161 located at an upper end of the rod 16 is placed in a hole 14B of the lever 14′. The rod end bearing 161 and a pin P1′ join the lever 14′ and the rod 16.

The fourth variant is characterized in that a plate 72 as a contact portion is suspended from the pin P1′ as a support portion provided in the lever 14′. The pin P1′ is used to achieve a compact structure as compared to the structure of the embodiment described above in FIG. 3.

The pin P1′ extends through the lever 14′ and protrudes from opposite side surfaces of the lever 14′ in a width direction.

A backup device 70 according to the fourth variant includes the pin P1′ and the plate 72 suspended from the pin P1′.

A nut 161N is secured to a shaft 161A of a body of the rod end bearing 161 of the main rod 16. The nut 161N and the plate 72 are in contact with each other. The plate 72 is integrally assembled to the main rod 16. The nut 161N and the plate 72 may work in the integrated manner.

Rod end bearings 73 that support the plate 72 above locking nuts 731 as locking portions are placed over portions of the pin P1′ protruding to opposite sides of the lever 14′. The locking nut 731 is secured to a shaft 73A of a body of the rod end bearing 73.

A clearance C is set between the plate 72 and the locking nut 731.

The rod end bearing 73 is also provided with another nut 732 above the plate 72. A gap exists between the nut 732 and the plate 72. The nut 732 restricts inadvertent upward movement of the plate 72.

The plate 72 extends in the width direction of the lever 14′. Shafts of the rod end bearings 161, 73, 73 extend through the plate 72.

If a portion 161B surrounding a ball of the body of the rod end bearing 161 is broken by wear or the like, the rod 16 is disengaged with the pin P1′ remaining in the lever 14′. At this time, the plate 72 provided on the rod 16 is displaced downward by the distance of the clearance C and locked by the locking nut 731, and thus the backup device 70 replaces joining of the lever 14′ and the main rod 16.

The nut 732 is placed with a predetermined gap from the plate 72 so that movement of the link mechanism 4 including the lever 14′ and the main rod 16 is not hindered after the backup device 70 replaces the joining of the lever 14′ and the main rod 16. The nut 732 is not always needed.

The fourth variant may be applied also to a joining portion of the lower end of the rod 16 and the front end of the feedback lever 15.

Other than those described above, the configurations provided in the embodiment described above may be chosen or changed to other configurations without departing from the gist of the present disclosure.

The structure of the link mechanism to which the backup device of the present disclosure is applied is not limited to that of the embodiment described above, but may include any combination of levers or rods. Also, the valve related to the link mechanism in the present disclosure is not limited to the regulating valve of the steam turbine, but any valve may be used.

In the embodiment described above, as shown in FIG. 3, the stand-by plate 22 is suspended from the clamp 21 provided on the regulating valve lever 14 using the rods 23, but if the stand-by plate 22 can be directly suspended from the regulating valve lever 14 without the clamp 21, there is no need for the clamp 21. For example, the stand-by plate 22 can be suspended from the regulating valve lever 14 by mounting the rods 23 to the thick portion 141 of the regulating valve lever 14.

Besides, the stand-by plate 22 may be suspended from the regulating valve lever 14 using a chain or a rope passed through a hole in the regulating valve lever 14 without the clamp 21 or the rod 23. Further, a member including a portion corresponding to the stand-by plate 22 may be directly mounted to the regulating valve lever 14. Specifically, the backup device of the present disclosure may only include a stand-by member suspended from the first link and located immediately below at least a part of the second link.

Also for the configuration in FIG. 6, if the main rod 16 includes a component replacing the support portion 31 including the support stopper 311 and the joining plate 312, there is no need for the support portion 31.

In the backup device 30 (FIG. 6) according to the embodiment described above, a spring having appropriate spring stiffness may replace the rod 33.

It is assumed that the stand-by plate 32 and the joining plate 312 are coupled via the spring. In that case, as the main rod 16 and the feedback lever 15 are disjoined and the feedback lever 15 is displaced downward by its own weight, the spring mounted to the feedback lever 15 is elastically deformed, and the stand-by plate 32 locks the feedback lever 15 by an elastic force of the spring.

What is claimed is:

1. A backup device for a link mechanism of a steam turbine, the link mechanism being configured to be involved in an operation of a valve provided in the steam turbine, and provided between the valve driven by oil pressure and an actuator to which an electric signal is supplied,
wherein the backup device comprises a locking portion configured to lock a contact portion of one of a first link and a second link included in the link mechanism by relative displacement of the first link and the second link caused by disjoining of the first link and the second link, on the other of the first link and the second link.

2. The backup device according to claim 1, further comprising a stand-by member as the locking portion suspended from the first link and located immediately below at least a part of the second link.

3. The backup device according to claim 2, further comprising a support portion that is provided on the first link and suspends the stand-by member.

4. The backup device according to claim 3, further comprising a rod that suspends the stand-by member from the support portion,
one end side of the rod is joined to the support portion by a pin, and
the other end side of the rod is joined to the stand-by member by a pin.

5. The backup device according to claim 4, wherein one end and the other end of the rod each have a rod end bearing into which the pin is inserted.

6. The backup device according to claim 3, wherein a pin that joins the first link and the second link is used as the support portion, and
the stand-by member is suspended from the pin.

7. The backup device according to claim 2, wherein the stand-by member is located immediately below a contact stopper provided on an outer peripheral portion of the second link.

8. The backup device according to claim 7, wherein at least one of the contact stopper and the stand-by member is formed into a spherical shape protruding toward the other.

9. The backup device according to claim 2, wherein the stand-by member is located immediately below at least an end of the second link.

10. The backup device according to claim 9, wherein the stand-by member is suspended from a support portion provided on an outer peripheral portion of the first link.

11. The backup device according to claim 2, wherein the link mechanism includes a third link connected to the second link, and
the backup device includes
a first stand-by member as the stand-by member located immediately below a contact stopper provided on an outer peripheral portion of the second link, and
a second stand-by member suspended from a support portion provided on the outer peripheral portion of the second link and located immediately below at least an end of the third link.

12. The backup device according to claim 2, wherein an intermediate link included in the link mechanism couples the first link and the second link, and
the stand-by member is suspended from the first link and located immediately below at least the end of the second link.

13. The backup device according to claim 1, wherein the valve is a regulating valve configured to regulate a flow rate of steam to be supplied to the steam turbine, and
the link mechanism includes
a regulating valve lever rockable according to an opening of the regulating valve, and
a feedback lever configured to coordinate with the regulating valve lever.

14. A steam turbine comprising a backup device according to claim 1.

15. A method for modifying a steam turbine that is a method for adding a backup device including a stand-by member to a link mechanism, the link mechanism being configured to be involved in an operation of a valve provided in the steam turbine, and provided between the valve driven by oil pressure and an actuator to which an electric signal is supplied,
wherein the method comprises a locking structure adding step of adding a locking structure to a first link and a second link included in the link mechanism, the locking structure being configured such that a locking portion configured to lock a contact portion of one of the first link and the second link by relative displacement of the first link and the second link caused by disjoining of the first link and the second link is provided on the other of the first link and the second link.

16. The method for modifying a steam turbine according to claim 15, wherein the locking structure adding step includes an immediately-below placing step of suspending the stand-by member from the first link to place the stand-by member immediately below at least a part of the second link.

17. The method for modifying a steam turbine according to claim 16, wherein the locking structure adding step includes a step of providing a clamp on the first link,
a step of providing a contact stopper on an outer peripheral portion of the second link, and
a step of mounting one end side of a rod to the clamp, and
in the immediately-below placing step,
the stand-by member is mounted to the other end side of the rod, and
the stand-by member is placed around the outer peripheral portion of the second link immediately below the contact stopper.

18. The method for modifying a steam turbine according to claim 16, wherein the locking structure adding step includes
a step of providing a support portion on an outer peripheral portion of the first link, and
a step of mounting one end side of a rod to the support portion, and
in the immediately-below placing step,
the stand-by member is mounted to the other end side of the rod below at least a part of the second link to be placed immediately below at least the part of the second link.
